(19) United States
(12) Patent Application Publication
(10) Pub. No.: US 2026/0046923 A1
(43) Pub. Date: Feb. 12, 2026

(54) METHODS, APPARATUS AND MEDIUM FOR EARLY SENSING AND POSITIONING WITH 2-STEP RACH

(71) Applicant: Huawei Technologies Co., Ltd., Shenzhen (CN)

(72) Inventors: Xi Zhang, Beijing (CN); Jianglei Ma, Ottawa (CA); Xiaoyan Bi, Shanghai (CN); Wen Tong, Ottawa (CA)

(21) Appl. No.: 19/317,849

(22) Filed: Sep. 3, 2025

Related U.S. Application Data
(63) Continuation of application No. PCT/CN2023/080225, filed on Mar. 8, 2023.

(51) Int. Cl. H04W 74/00; H04W 64/00; H04W 74/0833

(52) U.S. Cl. CPC H04W 74/004; H04W 64/00; H04W 74/0833

(57) ABSTRACT

Mechanisms for early uplink (UL) sensing and/or positioning are provided by including sensing and/or positioning information in Msg-A PUSCH of a 2-step RACH procedure. Other embodiments involve collaborative sensing by neighbor UEs over RACH occasions, exploiting sensing and/or positioning information that is included in Msg-A PUSCH of a 2-step RACH procedure.

### CROSS REFERENCE

The application is a continuation of International Application No. PCT/CN2023/080225, filed on Mar. 8, 2023, the disclosure of which is hereby incorporated by reference in its entirety.

### TECHNICAL FIELD

The application relates to wireless communications generally, and more specifically to systems and methods of sensing and positioning.

### BACKGROUND

In 5G New Radio (NR), to establish the communication link between a user equipment (UE) and a base station (BS) such as a next generation node B (gNB), a 4-step random access procedure, which is for short referred to as 4-step Random Access Channel (RACH) due to the inherent transmission of RACH, was initially supported in Release 15 (R15), and a shortened 2-step RACH procedure was later supported in R16. The 2-step RACH procedure depicted in FIG. 5B involves two messages referred to as Msg-A and Msg-B. Msg-A, which is transmitted from UE to a BS in the first step, consists of both a physical random access channel (PRACH) and a physical uplink shared channel (PUSCH). The 4-step RACH depicted in FIG. 5A involves four messages referred to as Msg-1, Msg-2, Msg-3 and Msg-4. With 4-step RACH, PUSCH is initially transmitted in a third step (i.e. Msg-3). Without initial timing estimation and adjustment from a preceding PRACH transmission, the Msg-A PUSCH of 2-step RACH may suffer from deteriorated detection performance, while the main advantage is to enable early initial PUSCH transmission with lower latency as compared with 4-step RACH.

The Msg-A PUSCH of 2-step RACH may include a Common Control Channel (CCCH) Service Data Unit (SDU) with a UE Contention Resolution Identity for UEs performing initial access, or a Cell Radio Network Temporary Identifier (C-RNTI) Medium Access Control (MAC) Control Element (CE) for UEs performing random access. As depicted in FIG. 6, Msg-A on PUSCH is scrambled with n_{RNTI}, the random-access preamble ID (n_{RAPID}), and additionally nm, where by default n_{ID}, is set to the physical cell ID. In 5G, these parameters are further defined as follows:
n_{ID}∈{0, 1, . . . , 1023} equals the higher-layer parameter dataScramblingIndentityPUSCH if configured and the RNTI equals C-RNTI, MCS-C-RNTI, SP-CSI-RNTI or CS-RNTI, and the transmission is not scheduled using DCI formation 0_0 in a common search space;
n_{ID}∈{0, 1, . . . , 1023} equals the higher-layer parameter msgA-DataScramblingIndex in configured and the PUSCH transmission is triggered by a Type-2 random access procedure;

$${n}_{ID} = {N}_{ID}^{cell}$$

otherwise
n_{RAPID} is the index of the random-access preamble transmitted for msgA
   and where n_{RNTI} equals the RA-RNTI for msgA and otherwise correspond to the RNTI associated with the PUSCH transmission.

With such a default scrambling scheme, the initial Msg-A PUSCH transmission from one UE can be decodable by all UEs with knowledge of the common RACH configuration in this cell, with blind detections similar to what is done at the BS side. Furthermore, in 5G NR, the cell-common RACH configuration is broadcasted via system information, with which the UEs in one cell are all made aware of the common RACH configuration in this cell.

In addition, for UE to initiate RACH transmission and connect to one BS, the BS is expected to perform periodic RACH reception according to the broadcasted RACH configuration. As it can be used for multiple functionalities including initial access, timing adjustment, beam failure recovery, and handover, in both forms of contention-based and contention-free RACH transmission, there are frequent RACH transmissions from UEs under the coverage area of one BS, or alternatively one cell. In addition, in 5G NR, the Synchronization Signal block (SSB)/Physical Broadcast Channel (PBCH) block transmission and RACH reception are typically beam swept for extended coverage, for example, there can be up to 8 SSBs for operations in Frequency Range 1 (FR1). In this case, there is a beam association between multiple SSBs and multiple RACH resources (or occasions), e.g. one-to-one mapping as depicted in FIG. 7, and with beam correspondence at the BS side, the BS is able to identify the beam sub-space of an accessing UE after receiving RACH from this UE.

### SUMMARY

According to one aspect of the present disclosure, there is provided a method comprising: a user equipment (UE) transmitting a Msg-A physical random access channel (PRACH) preamble and a Msg-A physical uplink shared channel (PUSCH) as part of Msg-A of a 2-step random access channel (RACH) procedure; wherein the PUSCH comprises sensing information and/or positioning information.

By including sensing information and/or positioning information as part of Msg-A of a 2-step RACH procedure, the network will have this information earlier than would otherwise be the case. This may, for example, be used to facilitate early narrow beamforming towards UE for better communication performance. This may, for example be used to facilitate BS sensing based on RACH transmissions received from UEs and positioning of UEs based on RACH transmissions received from those UEs.

In some embodiments, the sensing information and/or positioning information comprises at least one sensing result obtained by the user equipment and/or at least one location result obtained by the user equipment.

In some embodiments, the sensing information and/or positioning information comprises assistance information for enabling sensing or enabling positioning of the UE by a network device that is in receipt of the transmitted PUSCH.

In some embodiments, the sensing and/or positioning information comprises at least one of: UE location obtained by the UE; UE sensing results from a paging or wake-up procedure; time of transmission for the Msg-A PRACH and/or the Msg-A PUSCH and/or a Msg-A PUSCH DMRS; angle of departure (AoD) for the Msg-A PRACH and/or the Msg-A PUSCH and/or the Msg-A PUSCH DMRS expressed in a global coordinate system; or AoD for the Msg-A PRACH and/or the Msg-A PUSCH and/or the Msg-A PUSCH DMRS expressed in a local coordinate system (LCS).

In some embodiments, the method further comprises: performing bi-static sensing based on a Msg-A PRACH and/or a Msg-A PUSCH and/or a Msg-A PUSCH DMRS of a 2-step RACH sent by another UE.

In some embodiments, performing bi-static sensing comprises performing bi-static sensing over RACH occasions associated with a same SSB and/or BS beam and/or the same paging occasions that the UE is located in or monitoring.

Advantageously, in some embodiments, with UEs performing bi-static sensing over RACH occasions, additional viewing and/or sensing angles and/or results in addition to those obtained by a BS at a fixed location may be acquired, which after merging may provide more comprehensive sensing results of the objects within the coverage area.

In some embodiments, the method further comprises: receiving signaling to configure a sensing scrambling ID for the Msg-A PUSCH.

In some embodiments, the method further comprises: transmitting signaling indicating UE capability in terms of maximum number of sensing measurements per RACH occasion.

In some embodiments, the method further comprises: receiving signaling to restrict UE sensing measurement to contention-free RACH occasions.

In some embodiments, the method further comprises: receiving signaling instructing the UE to prioritize RACH transmission for beam failure recovery over performing sensing measurements at RACH occasions.

According to another aspect of the present disclosure, there is provided an apparatus comprising: a processor and a memory, the apparatus configured to perform the method as described herein.

According to another aspect of the present disclosure, there is provided a method comprising: a network device receiving a Msg-A physical random access channel (PRACH) preamble and a Msg-A physical uplink shared channel (PUSCH) as part of Msg-A of a 2-step random access channel (RACH) procedure; wherein the PUSCH comprises sensing information and/or positioning information.

In some embodiments, the sensing information and/or positioning information comprises at least one sensing result obtained by the user equipment and/or at least one location result obtained by the user equipment.

In some embodiments, the sensing information and/or positioning information comprises assistance information for enabling sensing or enabling positioning of the UE by the network device.

In some embodiments, the sensing and/or positioning information comprises at least one of: UE location obtained by the UE; UE sensing results from a paging or wake-up procedure; time of transmission for the Msg-A PRACH and/or the Msg-A PUSCH and/or a Msg-A PUSCH DMRS; angle of departure (AoD) for the Msg-A PRACH and/or the Msg-A PUSCH and/or the Msg-A PUSCH DMRS expressed in a global coordinate system; or AoD for the Msg-A PRACH and/or the Msg-A PUSCH and/or the Msg-A PUSCH DMRS expressed in a local coordinate system (LCS).

In some embodiments, the method comprises: receiving bi-static sensing results from a UE based on a Msg-A PRACH and/or a Msg-A PUSCH and/or a Msg-A PUSCH DMRS of a 2-step RACH received by the UE.

In some embodiments, the method comprises: transmitting signaling to configure a sensing scrambling ID for the Msg-A PUSCH.

In some embodiments, the method comprises: receiving signaling indicating UE capability in terms of maximum number of sensing measurements per RACH occasion.

In some embodiments, the method comprises: transmitting signaling to restrict UE sensing measurement to contention-free RACH occasions.

In some embodiments, the method comprises: transmitting signaling instructing the UE to prioritize RACH transmission for beam failure recovery over performing sensing measurements at RACH occasions.

According to another aspect of the present disclosure, there is provided a network device comprising: a processor and a memory, the network device configured to perform the method as described herein.

According to another aspect of the present disclosure, there is provided a computer program product comprising a non-transitory computer readable medium storing programming for execution by a processor, the programming including instructions to perform the method as described herein.

### BRIEF DESCRIPTION OF THE DRAWINGS

Embodiments of the disclosure will now be described with reference to the attached drawings in which:

FIG. 1 is a block diagram of a communication system;

FIG. 2 is a block diagram of a communication system;

FIG. 3 is a block diagram of a communication system showing a basic component structure of an electronic device (ED) and a base station;

FIG. 4 is a block diagram of modules that may be used to implement or perform one or more of the steps of embodiments of the application;

FIG. 5A depicts a 4-step RACH procedure and FIG. 5B depicts a 2-step RACH procedure;

FIG. 6 shows examples of scrambling of Msg-A PUSCH of a 2-step RACH procedure;

FIG. 7 is an example of beam association between beam-swept SSB transmission and RACH reception;

FIG. 8 is an example of a 2-step RACH procedure, in which sensing and/or positioning information is included in Msg-A PUSCH;

FIG. 9 is an example of including TOT and AoD in LCS in Msg-A PUSCH for uplink NLOS positioning;

FIG. 10 is an illustration of collaborate sensing by neighbor UEs over RACH occasions;

FIG. 11 is an example of collaborative sensing using reflected RACH;

FIG. 12 is an example of receive beam determination for collaborative sensing over reflected RACH;

FIG. 13 is a flowchart of a method for execution by a UE; and

FIG. 14 is a flowchart of a method for execution by a network device.

### DETAILED DESCRIPTION

Embodiments of the application involve the use of RACH transmissions in cellular networks, which are originally intended for communication purposes (for example for initial access or random access, uplink timing estimation, beam failure recovery, and handover), to provide positioning functionality, and/or sensing functionality or serve sensing purposes. Using the RACH to convey positioning information and/or sensing results provides such positioning information and/or sensing results to the network relatively early compared to conventional methods.

The early provision of sensing results and/or positioning information can be exploited for better communication performance. For example, early sensing of radio propagation environment or positioning of UE can be used to enable faster initial access or faster wake-up from sleeping. Advantageously, existing communication signals are re-used for sensing purpose, which delivers sensing services and/or results without the introduction of significant additional latency or overhead.

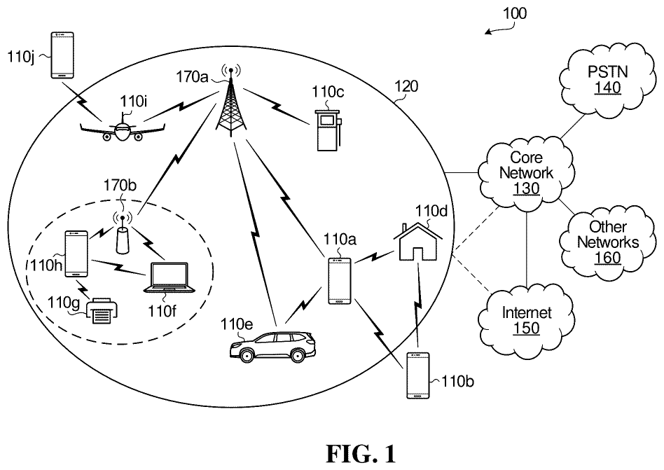

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

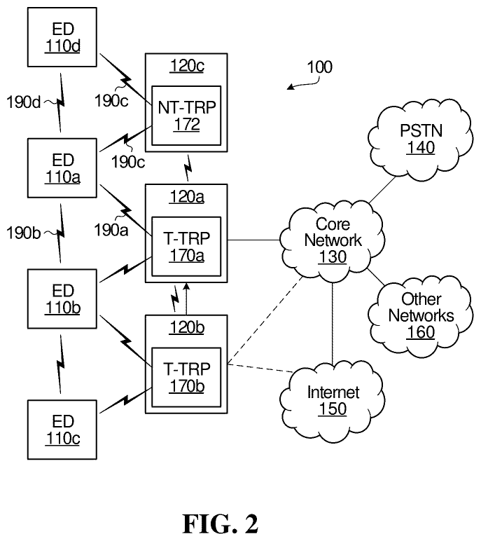

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130 and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some, or all, of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies and may incorporate multiple transceivers necessary to support such operation.

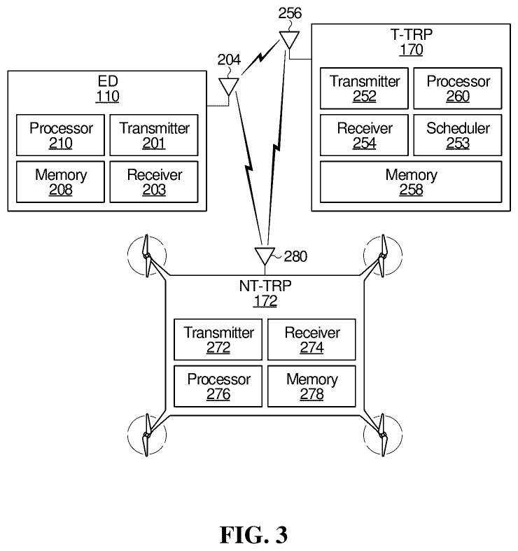

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random-access memory (RAM), read-only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

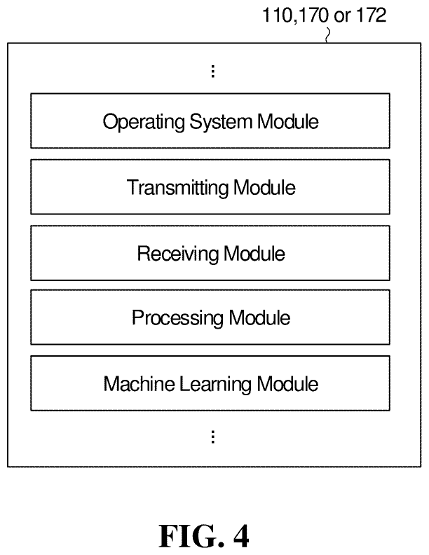

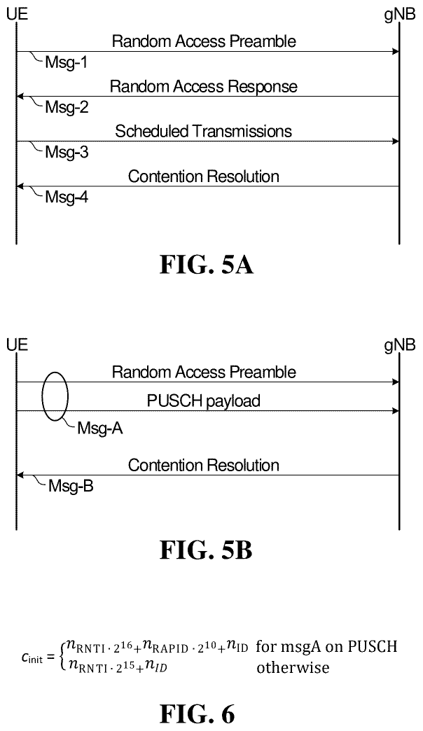

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor, for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

Embodiments of the application provide mechanisms for relatively early uplink (UL) sensing and/or positioning opportunity by including sensing and/or positioning information in Msg-A PUSCH of a 2-step RACH procedure. Other embodiments involve collaborative sensing by neighbor UEs over RACH occasions, exploiting sensing and/or positioning information that is included in Msg-A PUSCH of a 2-step RACH procedure.

For the purpose of this description, a 2-step RACH procedure is any procedure that involves a first step consisting of a transmission by a UE, referred to herein as message A, or Msg-A, followed by a second step consisting of a transmission by the network, referred to herein as message B, or Msg-B. The transmission by the UE in the first step may include multiple components such as a random access preamble (e.g. Msg-A PRACH), a PUSCH payload (e.g. Msg-A PUSCH) and PUSCH Demodulation Reference Signal (DMRS) (e.g. Msg-A PUSCH DMRS). In some embodiments, PRACH and PUSCH are always included in Msg-A and the PUSCH DMRS is optional. The 2-step RACH procedure used to convey sensing and/or positioning information may, for example, be based on the R16 2-step RACH, but more generally, this need not be the case.

In this embodiment, early UL sensing and/or positioning is achieved by including sensing and/or positioning-related information in Msg-A PUSCH of 2-step RACH procedure. One or both of two different categories of positioning and/or sensing information are included in Msg-A PUSCH of 2-step RACH procedure.

The first category of information is one or more UE positioning results and/or sensing results. Examples of a UE positioning result include a UE location estimate from another source accessible by the UE if available. Specific examples include an estimate of UE location from GPS, an estimate of height from a barometer sensor, an estimate of UE location from an Assisted Global Navigation Satellite System (A-GNSS), Wireless Local Area Network (WLAN), Bluetooth (BT), Terrestrial Beacon System (TBS), or High Accuracy Global Navigation Satellite System (HA-GNSS), an estimate of UE movement status and/or moving speed and/or moving direction from a motion sensor, an estimate of UE location from solutions based on Downlink (DL) Time Difference of Arrival (TDOA), or DL Angle of Departure. In some embodiments, this kind of UE positioning information is used by the network to facilitate more accurate BS beamforming towards this UE at an early stage. Note that RACH transmission here may include Msg-A PRACH and Msg-A PUSCH, and optionally Msg-A PUSCH DMRS.

An example of a sensing result is a sensing report in a paging or wake-up process. For example, a sensing result may be obtained from SSB or CSI-RS for tracking or tracking reference signal (TRS) reception during a paging or wake-up process. In some embodiments, this kind of UE sensing information is used to enable early feedback or update of surrounding objects identified by a UE from UE sensing.

The second category is assistance information that, rather than being a direct sensing result or positioning result, is for enabling sensing or enabling positioning of the UE at the BS side.

One example of assistance information for enabling positioning of the UE at the BS side is Time of transmission (ToT) for Msg-A PRACH and/or Msg-A PUSCH and/or Msg-A PUSCH DMRS. In some embodiments, such assistance information is used to enable UL Line of Sight (LOS) positioning with estimated Time of Flight (ToF) and AoA at the BS side.

Another example of assistance information for enabling positioning of the UE at the BS side is AoD for Msg-A PRACH and/or Msg-A PUSCH and/or Msg-A PUSCH DMRS. In some embodiments, AoD is expressed in a global coordinate system (GCS). This may, for example, be reported along with a UE positioning result (UE location) in Msg-A PUSCH in a situation where an estimate of the UE's location is known to itself.

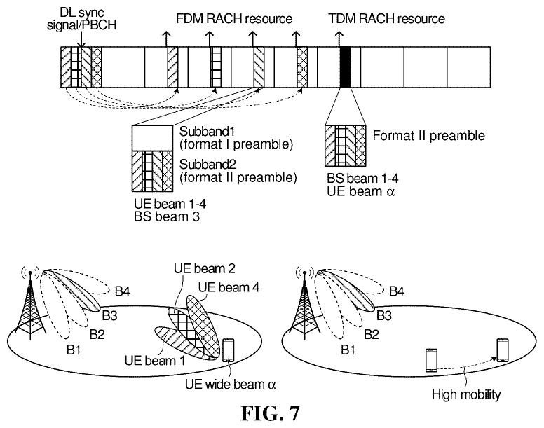

An example is shown in FIG. 8. Shown is a UE 800 transmitting Msg-A at 804, and a BS 802 transmitting Msg-B at 806. Msg-A includes UE location and also includes AoD expressed in the GCS. The provision of this information would facilitate BS sensing based on RACH transmissions received from UEs. Also shown is the transmission of SSB or system information (SI) at 803 by the BS 802. Note that this may not be considered as part of the 2-step RACH, but something that is transmitted on an ongoing basis in the background to facilitate access. In some embodiments, described in further detail below, the SSB or SI transmission 803, possibly in the form of master information block (MIB) or system information block (SIB), is used to configure what sensing information and/or positioning information to include in Msg-A PUSCH.

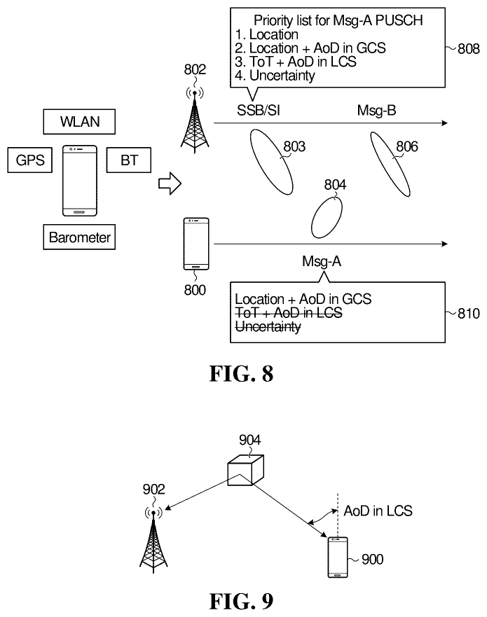

In some embodiments, AoD is expressed in a local coordinate system (LCS), for example relative to a reference direction (e.g. the direction of gravity). In some embodiments, the provision of this information is used to enable UE Non-Line-of-Sight (NLOS) positioning with respect to a known reflector. An example is shown in FIG. 9 which shows a UE 900, BS 902, and known reflector 904. The UE transmits information that includes the TOT and AoD in the LCS for NLOS positioning.

In other embodiments, different combinations of sensing and positioning information are included in Msg-A PUSCH of 2-step RACH procedure. Five examples have been presented above including:
Information 1: UE location estimate from another source if available;
Information 2: Sensing report in paging or wake-up process, e.g. measured from synchronization signal block (SSB) and/or tracking reference signal (TRS) during paging or wake-up process;
Information 3: Time of transmission (ToT) for Msg-A PRACH and/or Msg-A PUSCH and/or Msg-A PUSCH DMRS;
Information 4: AoD for Msg-A PRACH and/or Msg-A PUSCH and/or Msg-A PUSCH DMRS expressed in global coordinate system;
Information 5: AoD for Msg-A PRACH and/or Msg-A PUSCH and/or Msg-A PUSCH DMRS expressed in local coordinate system.

Following the item indexing used above for the five example types of information, several examples of combinations of sensing and/or positioning information are provided below.

First example: Information #1 and information #2 may be reported together in Msg-A PUSCH for accurate BS beamforming towards this UE at an early stage and/or BS sensing based on RACH transmissions received from UEs and/or early feedback or update of surrounding objects identified by UE from UE sensing.

Second example: Information #1 and information #4 may be reported together in Msg-A PUSCH for accurate BS sensing based on RACH transmissions received from UEs, i.e. exploiting knowledge of UE location and UE Transmit (Tx) beam direction.

Third example: Information #3 and information #5 may be reported together in Msg-A PUSCH for BS to estimate the position of one UE based on the received RACH transmission, in particular, with UL NLOS positioning with reflector location known to the BS, as illustrated in FIG. 9.

In some embodiments, uncertainty information may be included for the information included in Msg-A PUSCH of 2-step RACH procedure. Examples of types of uncertainty information that might be included are: maximum possible error in reported estimate of UE location, maximum possible error in reported ToT, maximum possible error in reported AoD in GCS or LCS. A single type of uncertainty information may be included, or a combination of two or more types of uncertainty information may be included. For improved privacy, such uncertainty information may be artificially and deliberately created and included.

To facilitate the inclusion of sensing and/or positioning information in Msg-A PUSCH of 2-step RACH procedure, some embodiments include use of one or more signaling procedures.

In some embodiments, broadcast or multicast or unicast signaling is transmitted from a BS to one or multiple UEs indicating which sensing and/or positioning information to include in Msg-A PUSCH in 2-step RACH procedure. For example, such signaling may indicate one or a supported combination of two or more of the 5 information examples listed above. Signaling may also or alternatively be used to convey the supported payload sizes of Msg-A PUSCH. An example is shown in FIG. 8, where SSB or SI 803, possibly in the form of MIB or SIB, is used to convey the priority among sensing and/or positioning information to be included in Msg-A PUSCH including the following: 1. Location; 2. Location—AoD in GCS; 3. ToT+AoD in LCS; 4. Uncertainty, where the location information is with highest priority.

In some embodiments, other than one or a combination of predefined rule(s), broadcast, multicast, or unicast signaling from a BS to one or multiple UEs is used to set a priority among a set of different types of sensing and/or positioning information, for example as among the five types listed above, for inclusion in Msg-A PUSCH in a 2-step RACH procedure with limited size for Msg-A PUSCH. In a specific example, one or multiple types of uncertainty information may be assigned with low priority and be dropped if the total size of information to include in Msg-A PUSCH exceeds a supported maximum value. An example is shown in FIG. 8 which shows a priority list at 808 transmitted in SSB or SI, possibly in the form of MIB or SIB, and the UE location and AoD in GCS are included at 810 while TOT and AoD in LCS and uncertainty information are omitted (illustrated through being crossed out) due to a size limitation of Msg-A PUSCH and low priority for such information.

In another example, uncertainty information may be assigned with higher priority if privacy is the primary concern.

One advantage of the described embodiments that provide for transmission of sensing and/or positioning information in Msg-A of 2-step RACH include enabling early provision of UE location estimate and UE sensing results to the BS side, and thereby facilitating early narrow beamforming towards the UE for better communication performance. Another advantage is facilitation of BS sensing based on RACH transmissions received from UEs and UL positioning of UEs based on RACH transmissions received from those UEs.

In this embodiment, systems and methods of collaborative sensing by neighbor UEs over RACH occasions are provided, to further exploit the presence of sensing and/or positioning information included in Msg-A PUSCH of 2-step RACH procedure as per the previously described embodiments. A neighbor UE of a given UE may, for example, be a UE in the same cell as the given UE.

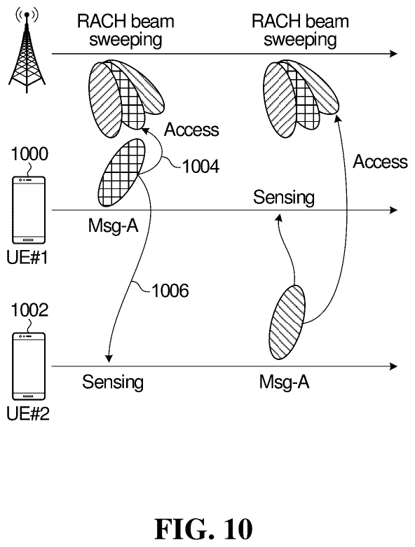

In some embodiments, neighbor UEs are configured to perform bi-static sensing over RACH occasions, exploiting sensing and/or positioning information included in the received and detected Msg-A PUSCH. The approach is illustrated by way of example in FIG. 10, where each of UE #1 1000 and UE #2 1002 may be monitoring possible RACH transmissions by other UE. FIG. 10 shows UE #1 1000 transmitting Msg-A including both PRACH and PUSCH and optionally PUSCH DMRS at 1004 for random access, with sensing and/or positioning information as per previously described embodiments included in the Msg-A PUSCH. UE #2 1002 is monitoring for such a transmission, and receives it at 1006, and after reading the sensing and/or positioning information included in Msg-A PUSCH, UE #2 may be able to perform bi-static sensing based on the received Msg-A PRACH, Msg-A PUSCH, and/or Msg-A PUSCH DMRS transmission from UE #1. For example, after reading out the location of UE #1 1000, and UE #1's Tx beam direction (e.g. AoD) and ToT for Msg-A PRACH, Msg-A PUSCH, and/or Msg-A PUSCH DMRS transmission from UE #1, the UE #2 1002 may perform bi-static sensing from the received Msg-A PRACH, Msg-A PUSCH, and/or Msg-A PUSCH DMRS, detecting environment information such as presence and size of objects nearby.

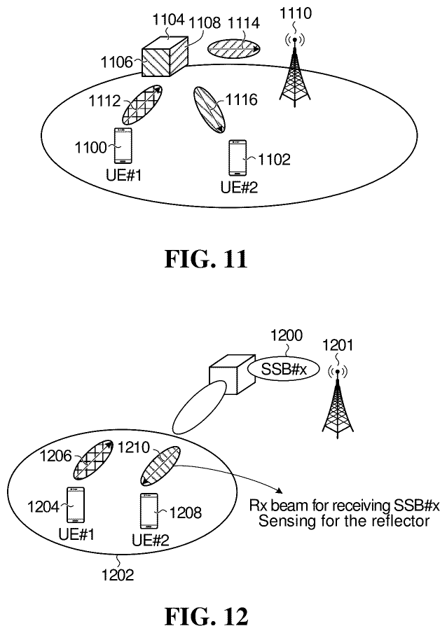

In some embodiments, the collaborative sensing scheme by neighbor UEs over RACH occasions is enabled by broadcasted 2-step RACH configuration and by the sensing and/or positioning information included in transmitted Msg-A PUSCH of 2-step RACH procedure. For example, as described in the previous embodiments, Msg-A PUSCH from other UEs may include UE location, ToT, and/or AoD in GCS for the RACH transmission which may include Msg-A PRACH and Msg-A PUSCH, and optionally Msg-A PUSCH DMRS. Such a collaborative sensing scheme may provide additional viewing and/or sensing angle in addition to that obtained by the BS at a fixed location. An example is shown in FIG. 11 which shows a first UE #1 1100, a second UE #2 1102, a reflector 1104 having first reflecting surface 1106 and second reflecting surface 1108, and a BS 1110. At 1112, UE #1 1100 has transmitted an access request in the form of Msg-A of 2-step RACH with sensing and/or positioning information included in Msg-A PUSCH. This is reflected by the second reflecting surface 1108 at 1114; the reflection is received by the BS 1110 which may respond to the access request from UE #1 by sending a random access response and/or acquire sensing results (e.g. distance, size) for the second reflecting surface 1108 of the reflector 1104 (e.g. a building) from the received Msg-A. In addition, the access request may be reflected by the first reflecting surface 1106 and UE #2 1102 may acquire sensing results for the first reflecting surface 1106 of the reflector 1104. If the sensing result at UE #2 is reported or shared with the BS 1110, together with the location of UE #2, the BS may then have a more comprehensive set of sensing results of the reflector from multiple viewing and/or sensing angles, e.g. including the sensed results for the first and second reflecting surfaces.

A new procedure is provided for one UE to determine RACH occasions and/or receive (Rx) beam (if any) for bi-static sensing based on RACH transmissions from other UEs. In one implementation, for a given UE, the RACH occasions associated with the same SSB and/or BS beam and/or the same paging occasions that the UE is located in or monitoring may be utilized for bi-static sensing based on RACH transmissions from other UEs. This may lead to a higher chance of receiving RACH transmissions from neighbor UEs, as those UEs are likely located within the coverage area of the same BS or SSB beam. An example is shown in FIG. 12 which shows SSB #x transmission at 1200 from a BS 1201, and an area 1202 that is covered by the reflected SSB #x. UE #1 1204 transmits a Msg-A of 2-step RACH at 1206. A receive (Rx) beam 1210 at UE #2 1208 that was used for receiving SSB #x is also used for receiving and performing bi-static sensing over the Msg-A transmitted from UE #1. In this example, UE #2 1208 may apply the receive beam that was used for receiving SSB #x to receive during the RACH occasions associated with SSB #x, or may choose only to receive during the RACH occasions associated with SSB #x when SSB #x is the serving beam for UE #2 1208. By taking this approach, the power consumption at the sensing UE may be reduced compared with a situation where bi-static sensing is performed over all possible RACH occasions.

In addition, a UE-selected Rx beam direction may also be applied if there is something the UE wants to check, which may help confirming non-existence of reflectors at one direction and/or location. In this case, the Rx beam direction selected by a UE may be reported to the BS (e.g. in the form of AoA) when reporting the sensing results obtained from RACH transmissions.

In some embodiments, a new sensing scrambling ID n_{ID}^{Sensing} is introduced for privacy-reserving collaborative sensing. In this case, via broadcast, multi-cast, or unicast signaling, a UE may be configured with a dedicated sensing scrambling ID for Msg-A PUSCH scrambling or Msg-A PUSCH DMRS scrambling when DMRS is present, which may replace any or all of RA-RNTI, the random-access preamble ID (RAPID), and additionally n_{ID}, which are currently used for Msg-A PUSCH scrambling in 5G NR. With this sensing scrambling ID provided, if a UE is to participate in collaborative sensing during 2-step RACH procedure, the UE may use the provided sensing scrambling ID for Msg-A PUSCH scrambling or Msg-A PUSCH DMRS scrambling when sensing and/or positioning information are included in Msg-A PUSCH. If a UE is not going to participate in collaborative sensing during 2-step RACH procedure, the UE may follow the existing Msg-A PUSCH scrambling scheme, e.g. using RA-RNTI, the random-access preamble ID (RAPID), and additionally n_{ID} for Msg-A PUSCH scrambling.

To facilitate collaborative sensing by neighbor UEs over RACH occasions, various signaling and procedures are provided. Which of these are included in a given implementation, if any, is application specific.

A first signaling procedure involves the use of signaling from a UE to a BS to indicate the UE's capability on sensing measurements over RACH occasions. For example, this may be used to indicate one or more of the following: maximum number of sensing measurements per RACH occasion, number of different cyclic shifts for blind detection, which may be reported per RACH sequence length and/or per Subcarrier Spacing (SCS) and/or per RACH occasion.

A second signaling procedure involves BS to UE signaling to facilitate UE bi-static sensing operations over RACH occasions with Msg-A transmitted from neighbor UEs. For example, this can include transmitting signaling to indicate a new sensing scrambling ID as described above, or to indicate information regarding a subset of RACH occasion/sequence(s) that are contention-free with which the amount of blind detections at UEs may be reduced.

A third signaling procedure is used for a UE to report of sensing results based on sensing measurement from RACH transmissions from neighbor UEs. This can, for example, be used to indicate detected preamble ID. In some embodiments, the signaling includes sensing and or location information indicated in a differential manner, relative to reference value or a reference location or to previous report, for reducing reporting overhead.

Signaling may be used to indicate priority and UE behavior when a collision occurs during a RACH occasion. For example, RACH transmission for beam failure recovery may be prioritized over sensing measurement when a UE is in half-duplex mode and unable to transmit RACH for itself while receiving RACH from neighbor UEs simultaneously.

Note that in some cases, for example, in a factory or fixed wireless access (FWA) scenarios, a UE may be equipped with a high-accuracy timing source (e.g. atomic clock) and large power reserves (or even plugged with power supply). In such a situation, the synchronization accuracy required for bi-static sensing operations and power consumption from frequent sensing over RACH occasions may not be a big concern.

An advantage for this embodiment may include that with UEs performing bi-static sensing over RACH occasions, additional viewing and/or sensing angles and/or results in addition to those obtained by the BS at a fixed location may be acquired, which after merging may provide more comprehensive sensing results for objects within the coverage area.

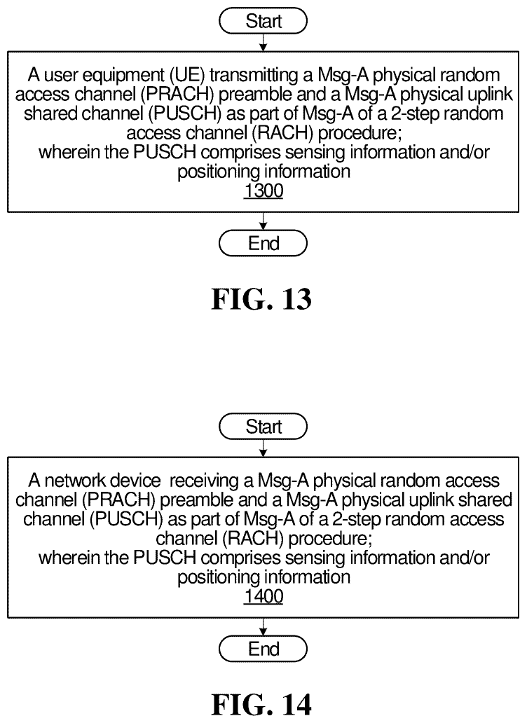

FIG. 13 is a flowchart of a method for execution by a UE. The method begins in block 1300 with a user equipment transmitting a Msg-A PRACH preamble and a Msg-A PUSCH as part of Msg-A of a 2-step RACH procedure. The PUSCH comprises sensing information and/or positioning information.

FIG. 14 is a flowchart of a method for execution by a network device. The method begins in block 1400 with a network device receiving a Msg-A PRACH preamble and a Msg-A PUSCH as part of Msg-A of a 2-step RACH procedure. The PUSCH comprises sensing information and/or positioning information.

The methods of FIGS. 13 and 14 can be implemented with any combination of the details described above.

Numerous modifications and variations of the present disclosure are possible in light of the above teachings. It is therefore to be understood that within the scope of the appended claims, the disclosure may be practiced otherwise than as specifically described herein.

1. A method at user equipment (UE) comprising:
transmitting a message A (Msg-A) physical random access channel (PRACH) preamble and a Msg-A physical uplink shared channel (PUSCH) as part of a Msg-A of a 2-step random access channel (RACH) procedure,
wherein the Msg-A PUSCH comprises sensing information or positioning information.

2. The method of claim 1,
wherein the sensing information or the positioning information comprises at least one sensing result obtained by UE, or,
the sensing information or the positioning information comprises at least one location result obtained by the UE.

3. The method of claim 1, wherein the sensing information or the positioning information comprises assistance information for enabling sensing or enabling positioning of the UE.

4. The method of claim 1, wherein the sensing or the positioning information comprises at least one of:
a UE location obtained by the UE;
UE sensing results from a paging or wake-up procedure;
time of transmission for at least one of the Msg-A PRACH preamble, the Msg-A PUSCH, or a Msg-A PUSCH DMRS;
an angle of departure (AoD) for at least one of the Msg-A PRACH preamble, the Msg-A PUSCH, or the Msg-A PUSCH DMRS expressed in a global coordinate system; or
an AoD for at least one of the Msg-A PRACH preamble, the Msg-A PUSCH, or the Msg-A PUSCH DMRS expressed in a local coordinate system (LCS).

5. The method of claim 1, further comprising:
receiving signaling to configure a sensing scrambling identifier (ID) for the Msg-A PUSCH.

6. An apparatus comprising:
at least one processor; and
a computer-readable storage media, having stored thereon, computer executable instructions, that when executed by the at least one processor, cause the apparatus to perform operations comprising:
transmitting a message A (Msg-A) physical random access channel (PRACH) preamble and a Msg-A physical uplink shared channel (PUSCH) as part of a Msg-A of a 2-step random access channel (RACH) procedure,
wherein the Msg-A PUSCH comprises sensing information or positioning information.

7. The apparatus of claim 6,
wherein the sensing information or the positioning information comprises at least one sensing result obtained by the apparatus, or
the sensing information or the positioning information comprises at least one location result obtained by the apparatus.

8. The apparatus of claim 6, wherein the sensing information or the positioning information comprises assistance information for enabling sensing or enabling positioning of the apparatus.

9. The apparatus of claim 6, wherein the sensing or the positioning information comprises at least one of:
an apparatus location obtained by the apparatus;
apparatus sensing results from a paging or wake-up procedure;
time of transmission for at least one of the Msg-A PRACH preamble, the Msg-A PUSCH, or a Msg-A PUSCH DMRS;
an angle of departure (AoD) for at least one of the Msg-A PRACH preamble, the Msg-A PUSCH, or the Msg-A PUSCH DMRS expressed in a global coordinate system; or
an AoD for at least one of the Msg-A PRACH preamble, the Msg-A PUSCH, or the Msg-A PUSCH DMRS expressed in a local coordinate system (LCS).

10. The apparatus of claim 6, the operations further comprising:
receiving signaling to configure a sensing scrambling identifier (ID) for the Msg-A PUSCH.

11. A method at a network device comprising:
receiving a message A (Msg-A) physical random access channel (PRACH) preamble and a Msg-A physical uplink shared channel (PUSCH) as part of a Msg-A of a 2-step random access channel (RACH) procedure,
wherein the Msg-A PUSCH comprises sensing information or positioning information.

12. The method of claim 11,
wherein the sensing information or the positioning information comprises at least one sensing result obtained by a user equipment (UE), or
the sensing information or the positioning information comprises at least one location result obtained by the UE.

13. The method of claim 11, wherein the sensing information or the positioning information comprises assistance information for enabling sensing or enabling positioning of a UE by the network device.

14. The method of claim 11, wherein the sensing or the positioning information comprises at least one of:
a UE location obtained by a UE;
UE sensing results from a paging or wake-up procedure;
time of transmission for at least one of the Msg-A PRACH preamble, the Msg-A PUSCH, or a Msg-A PUSCH DMRS;
an angle of departure (AoD) for at least one of the Msg-A PRACH preamble, the Msg-A PUSCH, or the Msg-A PUSCH DMRS expressed in a global coordinate system; or
an AoD for at least one of the Msg-A PRACH preamble, the Msg-A PUSCH, or the Msg-A PUSCH DMRS expressed in a local coordinate system (LCS).

15. The method of claim 11, further comprising:
transmitting signaling to configure a sensing scrambling identifier (ID) for the Msg-A PUSCH.

16. A network device comprising:
at least one processor; and
a computer-readable storage media, having stored thereon, computer executable instructions, that when executed by the at least one processor, cause the network device to perform operations comprising:
receiving a message A (Msg-A) physical random access channel (PRACH) preamble and a Msg-A physical uplink shared channel (PUSCH) as part of a Msg-A of a 2-step random access channel (RACH) procedure,
wherein the Msg-A PUSCH comprises sensing information or positioning information.

17. The network device of claim 16,
wherein the sensing information or the positioning information comprises at least one sensing result obtained by a user equipment (UE), or
the sensing information or the positioning information comprises at least one location result obtained by the UE.

18. The network device of claim 16, wherein the sensing information or the positioning information comprises assistance information for enabling sensing or enabling positioning of a UE by the network device.

19. The network device of claim 16, wherein the sensing or the positioning information comprises at least one of:
a UE location obtained by a UE;
UE sensing results from a paging or wake-up procedure;
time of transmission for at least one of the Msg-A PRACH preamble, the Msg-A PUSCH, or a Msg-A PUSCH DMRS;
an angle of departure (AoD) for at least one of the Msg-A PRACH preamble, the Msg-A PUSCH, or the Msg-A PUSCH DMRS expressed in a global coordinate system; or
an AoD for at least one of the Msg-A PRACH preamble, the Msg-A PUSCH, or the Msg-A PUSCH DMRS expressed in a local coordinate system (LCS).

20. The network device of claim 16, the operations further comprising:
transmitting signaling to configure a sensing scrambling identifier (ID) for the Msg-A PUSCH.
